(19) United States
(12) Patent Application Publication
(10) Pub. No.: US 2025/0383815 A1
(43) Pub. Date: Dec. 18, 2025

(54) KEY IDENTIFIER CHECK IN A COMPUTE EXPRESS LINK (CXL) MEMORY DEVICE

(71) Applicant: MICRON TECHNOLOGY, INC., Boise, ID (US)

(72) Inventors: Danilo Caraccio, Milano (IT); Marco Sforzin, Cernusco sul Naviglio (IT)

(21) Appl. No.: 19/207,503

(22) Filed: May 14, 2025

Related U.S. Application Data
(60) Provisional application No. 63/659,666, filed on Jun. 13, 2024.

(51) Int. Cl. G06F 3/06

(52) U.S. Cl. CPC G06F 3/0659; G06F 3/061; G06F 3/0679

(57) ABSTRACT

A system can include a memory device; and a processing device, operatively coupled with the memory device, to perform operations including: receiving a write command comprising first data and a first key identifier; performing a first computation on the first data and the first key identifier to generate second data; storing the second data in the memory device; and storing a parity value of the second data in the memory device.

### RELATED APPLICATIONS

This application claims the benefit of U.S. Provisional Patent Application No. 63/659,666, filed Jun. 13, 2024, the entire contents of which are incorporated by reference herein.

### TECHNICAL FIELD

Embodiments of the disclosure relate generally to memory sub-systems, and more specifically, relate to a key identifier check in a compute express link (CXL) memory device.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system in accordance with some embodiments of the present disclosure.

FIG. 2 is a block diagram of an example system for implementing key identifier check in a compute express link (CXL) memory device in accordance with some embodiments of the present disclosure.

FIG. 3 is a flow diagram of an example method for implementing key identifier check for a write command in a compute express link (CXL) memory device in accordance with some embodiments of the present disclosure.

FIG. 4 is a flow diagram of an example method for implementing key identifier check for a read command in a compute express link (CXL) memory device in accordance with some embodiments of the present disclosure.

FIG. 5 illustrates an example of multi-tentative correction in accordance with some embodiments of the present disclosure.

FIG. 6 illustrates an example of keyID-checked data in accordance with some embodiments of the present disclosure.

FIG. 7 is a block diagram of an example computer system in which embodiments of the present disclosure may operate.

### DETAILED DESCRIPTION

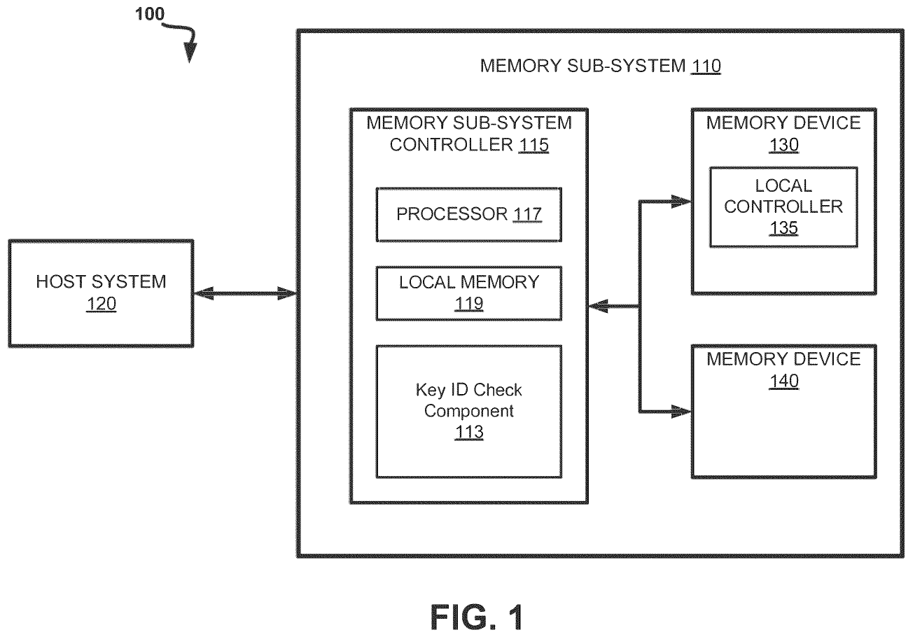

Aspects of the present disclosure are directed to implementing a key identifier check in a compute express link (CXL) memory device. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a not-and (NAND) memory device. Other examples of non-volatile memory devices are described below in conjunction with FIG. 1. A non-volatile memory device is a package of one or more dies. Each die can include one or more planes. For some types of non-volatile memory devices (e.g., NAND devices), each plane includes a set of physical blocks. Each block includes a set of pages. Each page includes a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values. Some types of memory, such as 3D cross-point, can group pages across dice and channels to form management units. A management unit can correspond to a page, a block, etc. In some instances, a group of management units that are grouped together for management purposes can be referred to as a super management unit.

A memory device can include a two-dimensional or three-dimensional grid of memory cells, which are formed onto a silicon wafer in an array of columns and rows. A memory cell includes a capacitor that holds an electric charge and a transistor that acts as a switch controlling access to the capacitor. Accordingly, the memory cell may be programmed (written to) by applying a certain voltage, which results in an electric charge being held by the capacitor. The memory cells are joined by wordlines, which are conducting lines electrically connected to the control gates of the memory cells, and bitlines, which are conducting lines electrically connected to the drain electrodes of the memory cells.

Data operations can be performed by the memory sub-system. The data operations can be host-initiated operations. For example, the host system can initiate a data operation (e.g., write, read, erase, etc.) on a memory sub-system. The host system can send access requests (e.g., write command, read command) to the memory sub-system, such as to store data on a memory device at the memory sub-system and to read data from the memory device on the memory sub-system. The data to be read or written, as specified by a host request, is hereinafter referred to as “host data.” A host request can include a logical address (e.g., a logical block address (LBA), namespace, or a host physical address (HPA)) for the host data, which is the location that the host system associates with the host data. The logical address information (e.g., LBA, namespace) can be part of metadata for the host data. “Data” hereinafter refer to host data and metadata of the host data. Some memory sub-systems can implement security keys utilized for memory encryption and store the key identifier (“key ID”) of the security key with the data. Storing the key ID, however, requires additional memory space. Also, a Key ID is overlaid on the data and can be removed from data only by the trusted device. Further, a tentative access to data without the correct Key ID will result in an error intercepted by the detection mechanism of the reliability, availability, and serviceability (RAS) system to block the access to data for security reasons. Access being blocked for security reasons could be confused with the access being blocked for uncorrectable errors, leading to an unknown explanation for the access blocking.

Aspects of the present disclosure address the above and other deficiencies by implementing a key ID check mechanism to store the data without using extra memory space for storing the key ID in a memory device, such as a compute express link (CXL) memory device. Specifically, a host system can send a write command to the CXL memory device, where the write command includes data (referred to as “first data” for easier description) and a key ID. For example, the key ID may be a context key identifier (CKID) for identifying security keys utilized for memory encryption using CXL-defined trusted execution environment (TEE) Security Protocol (TSP). A controller of the CXL memory device may perform a computation (referred to as “first computation” for easier description) on the first data and the key ID to generate keyID-checked data (referred to as “second data” for easier description). The purpose of the first computation is to make the size of the second data the same as the size of the first data, which can be considered as if the key ID is “checked in”. As such, the size of the second data would be smaller than the sum of the size of the first data and the size of the key ID, saving memory space that is supposed to be used for storing the key ID without the key ID check mechanism. The first computation, for example, may be an exclusive-or (XOR) operation of the first data and the key ID. The controller of the CXL memory device may store the second data in the memory device.

To detect errors associated with the stored data and provide data recovery in case of error occurrence, the controller of the CXL memory device may generate parity data of the second data, where the parity data can be used to reconstruct or recalculate the second data in the event of a failure of a portion of the memory device that is storing the second data. The controller of the CXL memory device may encode the first data by applying a cyclic redundancy check (CRC) code (or a message authentication code (MAC), or the like) to the first data to generate a CRC (or MAC) encoding value, where the CRC (or MAC) encoding value can be used to detect an error occurrence associated with the first data. The controller of the CXL memory device may store, along with the second data, the parity data and the CRC (or MAC) encoding value in the memory device.

The host system can send a read command to the CXL memory device, where the read command includes an address indicating the second data and the key ID. The controller of the CXL memory device may retrieve the second data according to the address and perform another computation (referred to as “second computation” for easier description) on the second data and the key ID included in the read command to generate read data (referred to as “third data” for easier description). The purpose of the second computation is to convert the second data back to its original form (i.e., “checked out”). The second computation, for example, may be an exclusive-or (XOR) operation of the second data and the key ID. To detect whether the third data is correctly converted back to its original form, the controller of the CXL memory device may decode the third data to generate a CRC (or MAC) decoding value and compare the generated CRC (or MAC) decoding value with the CRC (or MAC) encoding value stored in the memory device. Responsive to determining that the CRC (or MAC) decoding value equals the CRC (or MAC) encoding value, the controller of the CXL memory device may determine that no error occurs and send the third data to the host system.

Responsive to determining that the CRC (or MAC) decoding value does not equal the CRC (or MAC) encoding value, the controller of the CXL memory device may determine that error occurs and perform a multi-tentative correction on the third data using the second data, the parity value, the CRC (or MAC) encoding value, the key ID. In some implementations, performing the multi-tentative correction on the third data may result in corrected third data, and the controller of the CXL memory device may send the corrected third data to the host system. In some implementations, performing the multi-tentative correction on the third data may result in a failure on correcting the third data, and the controller of the CXL memory device may send an error notification to the host system. Although the CXL memory device is illustrated as an example of the memory device, other types of memory devices are applicable to the aspects of the present disclosure.

Advantages of the present disclosure include but are not limited to efficient use of key identifiers without the need of extra memory space for storing the key identifiers. Specifically, the key identifiers, such as security keys utilized for memory encryption using CXL-defined trusted execution environment (TEE) Security Protocol (TSP), can be checked to save the memory resource of the CXL device to be used for other purpose.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs). The memory sub-system 110 may include a device using compute express link (CXL) interface described below.

The computing system 100 can be a computing device such as a desktop computer, laptop computer, network server, mobile device, a vehicle (e.g., airplane, drone, train, automobile, or other conveyance), Internet of Things (IOT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The NVMe interface is a communications interface/protocol developed for SSDs to operate over a host and a memory device that are linked over a PCle interface. The NVMe protocol provides a command queue and completion path for access of data stored in memory devices by host system 220. In some embodiments, the interface between the host system and the memory device can implement one or more alternate protocols supported by another interface standard. For example, the interface can implement one or more alternate protocols supported by PCIe (e.g., non-PCIe protocols). In some embodiments, the interface can be represented by the compute express link (CXL) interface or any communication link that allows cache line granularity updates and shares coherency control with the processing device.

A CXL system is a cache-coherent interconnect for processors, memory expansion, and accelerators. A CXL system maintains memory coherency between the CPU memory space and memory on attached devices, which allows resource sharing for higher performance, reduced software stack complexity, and lower overall system cost. Generally, CXL is an interface standard that can support a number of protocols that can run on top of PCle, including a CXL.io protocol, a CXL.mem protocol and a CXL.cache protocol. The CXL.io protocol is a PCIe-like protocol that can be viewed as an “enhanced” PCIe protocol capable of carving out managed memory. CXL.io can be used for initialization, link-up, device discovery and enumeration, register access, and can provide an interface for I/O devices. The CXL.mem protocol can enable host access to the memory of an attached device using memory semantics (e.g., load and store commands). This approach can support both volatile and persistent memory architectures. The CXL.cache protocol can define host-device interactions to enable efficient caching of host memory with low latency using a request and response approach. Traffic (e.g., NVMe traffic) can run through the CXL.io protocol, and the CXL.mem and CXL.cache protocols can share a common link layer and transaction layer. Accordingly, the CXL protocols can be multiplexed and transported via a PCIe physical layer.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a not-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks. Some types of memory, such as 3D cross-point, can group pages across dice and channels to form management units.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processors.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical MU address, physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

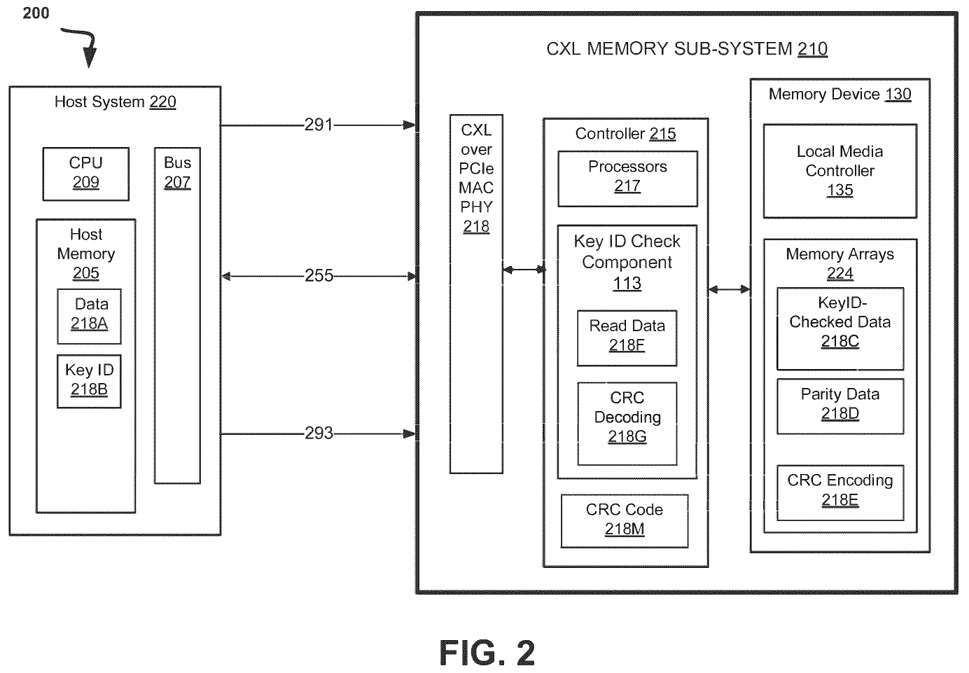

In some embodiments, the memory sub-system 110 includes a key ID check component 113. In some embodiments, the memory sub-system controller 115 includes at least a portion of the key ID check component 113. In some embodiments, the key ID check component 113 is part of the host system 110, an application, or an operating system. In other embodiments, local media controller 135 includes at least a portion of key ID check component 113 and is configured to perform the functionality described herein. Further details regarding the operations of the key ID check component 113 are described below with reference to FIGS. 2-7.

It will be appreciated by those skilled in the art that additional circuitry and signals can be provided, and that the components of FIG. 1 have been simplified. It should be recognized that the functionality of the various block components described with reference to FIG. 1 may not necessarily be segregated to distinct components or component portions of an integrated circuit device. For example, a single component or component portion of an integrated circuit device could be adapted to perform the functionality of more than one block component of FIG. 1. Alternatively, one or more components or component portions of an integrated circuit device could be combined to perform the functionality of a single block component of FIG. 1.

FIG. 2 is a schematic block diagram of a system 200 including a compute express link (CXL) memory device. In various embodiments, the system 200 includes a host system 220 (e.g., the host system 120), a CXL memory sub-system 210 (e.g., the memory sub-system 110) that includes a controller 215 (e.g., controller 115), a memory device 130 that includes a local media controller 135 and memory arrays 224. In some embodiments, aspects (to include hardware and/or firmware functionality) of the controller 215 is included in the local media controller 135.

In some embodiments, the host system 220 includes a central processing unit (CPU) 209 connected to a host memory 205, such as DRAM or other main memories. The host system 220 includes a bus 207, such as a memory device interface, which interacts with a host interface 218, via a CXL connection 255. The CXL connection 255 can include a set of data-transmission lanes (“lanes”) for implementing CXL protocols, including CXL.io protocol, CXL.mem protocol, and CXL.cache protocol. The CXL connection 255 can include any suitable number of lanes in accordance with the embodiments described herein. For example, the CXL connection 255 can include 16 lanes (i.e., CXL x16).

The host interface 218 may include media access control (MAC) and physical layer (PHY) components, of CXL memory sub-system 210 for ingress of communications from host system 220 to CXL memory sub-system 210 and egress of communications from CXL memory sub-system 210 to host system 220. Bus 207 and host interface 218 operate under a communication protocol, such as a CXL over PCIe serial communication protocol or other suitable communication protocols. Other suitable communication protocols include Ethernet, serial attached SCSI (SAS), serial AT attachment (SATA), any protocol related to remote direct memory access (RDMA) such as Infiniband, iWARP, or RDMA over Converged Ethernet (RoCE), and other suitable serial communication protocols.

CXL memory sub-system 210 may include a controller 215 (e.g., processing device) which manages operations of CXL memory sub-system 210, such as writes to and reads from memory arrays 224. Controller 215 may include one or more processors 217, which may be multi-core processors. Processors 217 can handle or interact with the components of memory device 130 generally through firmware code. Controller 215 may operate under NVM Express (NVMe) or CXL protocol, but other protocols are applicable. Controller 215 executes computer-readable program code (e.g., software or firmware) executable instructions (herein referred to as “instructions”). The instructions may be executed by various components of controller 215, such as processor 217, logic gates, switches, application specific integrated circuits (ASICs), programmable logic controllers, embedded microcontrollers, and other components of controller 215. The instructions executable by the controller 215 for carrying out the embodiments described herein are stored in a non-transitory computer-readable storage medium. In certain embodiments, the instructions are stored in a non-transitory computer readable storage medium of CXL memory sub-system 210, such as in a read-only memory (ROM). Instructions stored in the CXL memory sub-system 210 may be executed without added input or directions from the host system 220. In other embodiments, the instructions are transmitted from the host system 220. The controller 215 is configured with hardware and instructions to perform the various functions described herein and shown in the figures. The controller 215 may communicate through the host interface 218 with the host system 220 and communicate with components of the CXL memory sub-system 210. Controller 215 can interact with the memory arrays 224 for read and write operations. Controller 215 can have an error correction module to correct the data fetched from the memory arrays in the memory arrays 224 (e.g., non-volatile memories that are used to store data provided by the host system 220).

The CXL memory sub-system 210 can use a striping scheme to treat various sets of data as units when performing data operations (e.g., write, read, erase, etc.) with memory arrays 224. A die stripe refers to a collection of planes that are treated as one unit when writing, reading, or erasing data. A block stripe is a collection of blocks, at least one from each plane of a die stripe, that are treated as a unit. The blocks in a block stripe can be associated with the same block identifier (e.g., block number) at each respective plane. A page stripe is a set of pages having the same page identifier (e.g., the same page number), across a block stripe, and treated as a unit. A management unit stripe is a collection of management units, at least one from each plane of a die stripe, a block stripe, a page stripe, etc., that are treated as a unit. A super management unit refers to a collection or group of management units that are grouped together for memory management purposes. Using as an illustrative example, the controller 215 can execute the same operation, in parallel, at each plane of a block stripe.

As data is accessed at a memory cell of the memory arrays 224, the memory cell can deteriorate and eventually become defective. For example, when the host system 220 initiates too many memory access operations for host data stored at the memory arrays 224, the memory cells that store the host data, as well as the adjacent memory cells at the memory device, can become corrupted, leading to memory access failures. To detect errors associated with the memory cells, the CXL memory sub-system 210 can support a cyclic redundancy check (CRC) (or message authentication code (MAC)) operation. As an example, the host system 220 can encode the data by appending a cyclic redundancy check (CRC) (or message authentication code (MAC)) code to the data and store the CRC (or MAC) code along with the data in the memory arrays 224. At a later time, the host system 220 can request access to the data, and in response, the CXL memory sub-system 210 can provide the requested data to the host system 220. The host system 220 can generate a new CRC (or MAC) code from the retrieved data and can compare the new CRC (or MAC) code with the original CRC (or MAC) code. If the two CRC (or MAC) codes match, then the host system 220 can determine that the retrieved data is valid (i.e., same as the original data requested to be stored). On the other hand, if the two CRC (or MAC) codes do not match, then the host system 220 can determine that the retrieved data is corrupted. In some cases, the CXL memory sub-system 210, instead of the host system 220, can perform the comparison using the new CRC (or MAC) code and the original CRC (or MAC) code and the determination of the validity of the retrieved data.

The CXL memory sub-system 210 can support a redundancy mechanism to protect the data against a memory access failure. For example, the CXL memory sub-system 210 can implement one or more redundancy operations (e.g., redundant array of independent devices (RAID) operations) to provide redundancy for the data stored on the memory arrays 224. When the data is received from the host system 220 to be programmed to the memory arrays 224, the controller 215 can generate redundancy metadata (e.g., parity data) based on an exclusive-or (XOR) operation with the received data and can use the redundancy metadata to reconstruct or recalculate the data in the event of a failure of a portion of the memory arrays 224 that is storing the data. As an example, the controller 215 can generate the parity data (e.g., a parity value) based on an XOR operation applied to data stored at a particular number of data locations of a management unit (e.g., a page, a block) of the memory arrays 224. If a portion of the memory arrays 224 storing the data fails and the corresponding data is lost or corrupted, the controller 215 can reconstruct the lost/corrupted data based on an XOR operation among the rest of the data and the parity value.

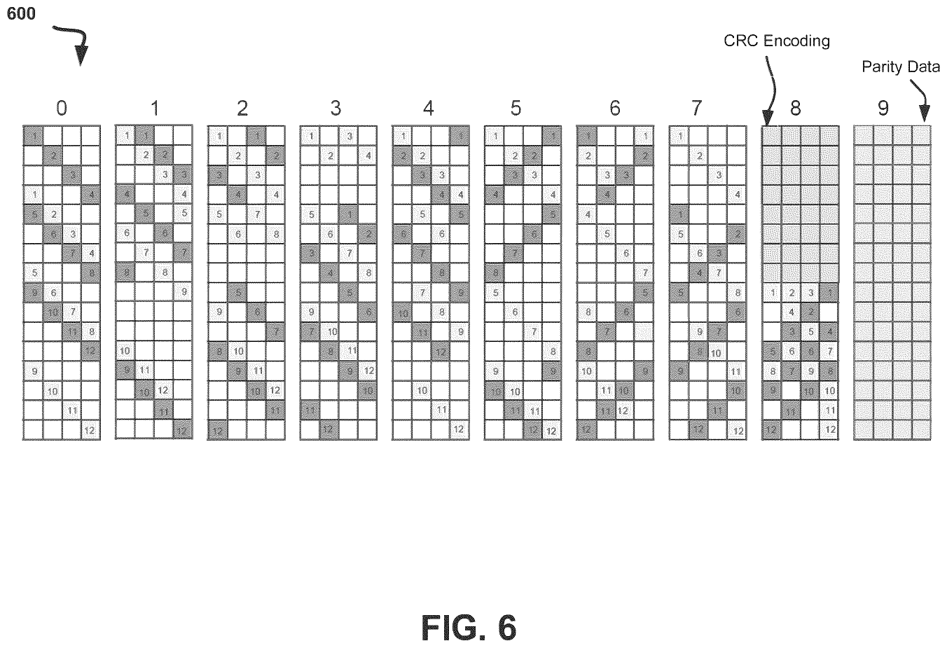

In some embodiments, the CXL memory sub-system 210 can support a specialized redundancy mechanism (e.g., locked RAID (LRAID)), in which the data in the access request are stored in multiple die stripes (e.g., D₁, . . . , Dₙ) and a same CRC (or MAC) code is applied to all die stripes associated with the access request. As illustrated below, FIG. 6 illustrates an example of the data stored in multiple die stripes, where a same CRC (or MAC) code is applied.

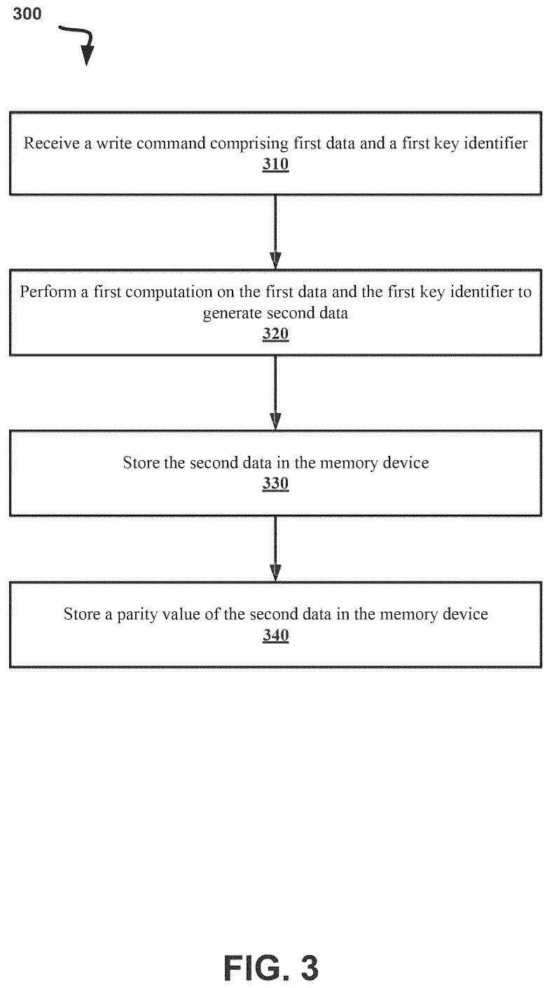

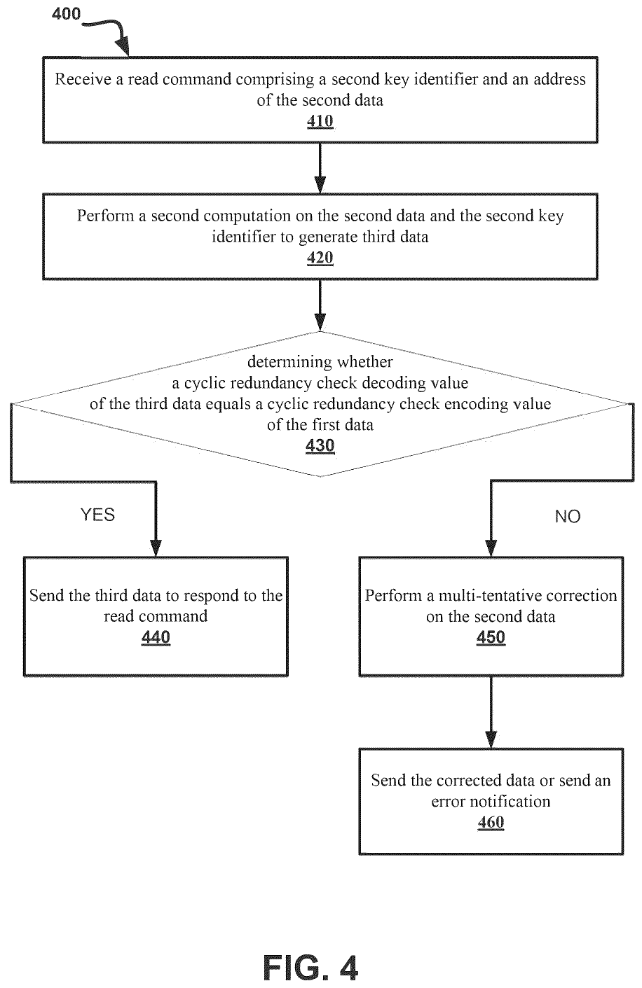

In some embodiments, the controller 215 further includes a key ID check component 113 coupled to or integrated with the processors 217 and the host interface 218, as will be discussed in more detail. The key ID check component 113 may be processing logic that can include hardware (e.g., processing device, circuitry, dedicated logic, programmable logic, microcode, hardware of a device, integrated circuit, etc.), firmware (e.g., instructions run or executed on the processors 217), or a combination thereof. The key ID check component 113 may receive commands from the host system 220. The commands can be different types, including write commands, or read commands. As illustrated below, FIG. 3 describes the operations of the key ID check component 113 (and/or controller 215) for write commands, while FIG. 4 describes the operations of the key ID check component 113 (and/or controller 215) for read commands.

Referring to FIG. 2, the host system 220 can send a write command 291 to write data 218A in the memory arrays 224. In some implementations, the data 218A may include the host data and the metadata of the host data, The write command 291 may include a key ID 218B. In some implementations, the key ID 218B may be a context key identifier (CKID) for identifying security keys utilized for memory encryption using CXL-defined trusted execution environment (TEE) Security Protocol (TSP). TEE provides a secure area that can guarantee data loaded inside to be protected with respect to confidentiality and integrity. TSP provides a collection of requirements and interfaces that allow memory devices to be utilized for confidential computing. For example, the CKID may reference preconfigured key material utilized for device-based data-at-rest encryption, where the device has been configured to utilize CKID-based device encryption and locked utilizing the CXL TEE security protocol (TSP).

The key ID check component 113 may perform a computation on the data 218A and the key ID 218B to generate the keyID-checked data 218C. The computation results in a non-change of the size of data 218A and the size of keyID-checked data 218C. That is, the size of keyID-checked data 218C is smaller than the combination of the size of data 218A and the size of key ID 218B. In some implementations, the computation may be an exclusive-or (XOR) operation of the data 218A and the key ID 218B. The key ID check component 113 may store the keyID-checked data 218C in the memory arrays 224.

To provide data recovery in case of errors, the key ID check component 113 may generate a parity data 218D of the keyID-checked data 218C, and the parity data 218D can be used to reconstruct or recalculate the keyID-checked data 218C in the event of a failure of a portion of the memory device that is storing the keyID-checked data 218C. In some implementations, generating the parity data 218D may involve performing an exclusive-or (XOR) operation with the keyID-checked data 218C.

To detect errors associated with the data 218A, the controller 215 can encode the data 218A by applying a CRC (or MAC) code 218M to the data 218A to generate a CRC (or MAC) encoding value 218E. The controller 215 can store the CRC (or MAC) encoding value 218E in the memory arrays 224.

Referring to FIG. 2, the host system 220 can send a read command 293 to read data that is stored as the keyID-checked data 218C in the memory arrays 224. In some implementations, the read command 293 may include an address of the keyID-checked data 218C. The read command 293 may include the key ID 218B. The key ID check component 113 may retrieve the keyID-checked data 218C from the memory arrays 224 according to the address.

The key ID check component 113 may perform a computation on the retrieved keyID-checked data 218C and the key ID 218B specified in the read command 293 to generate the read data 218F. The computation is a reverse function to convert the keyID-checked data 218C to the form that is before the key ID check. In some implementations, the computation may be an exclusive-or (XOR) operation of the keyID-checked data 218C and the key ID 218B.

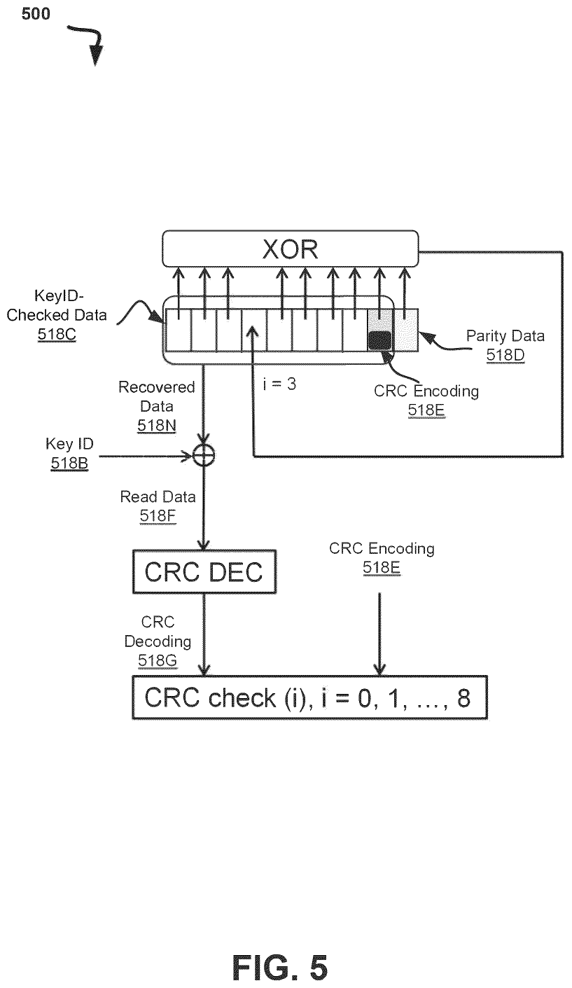

The key ID check component 113 may decode the read data 218F to derive a CRC (or MAC) decoding value 218G. The key ID check component 113 may determine whether CRC (or MAC) decoding value 218G equals the CRC (or MAC) encoding value 218E. Responsive to determining that CRC (or MAC) decoding value 218G equals the CRC (or MAC) encoding value 218E, the key ID check component 113 may send the read data 218F to the host system 220. Responsive to determining that CRC (or MAC) decoding value 218G does not equal the CRC (or MAC) encoding value 218E, the key ID check component 113 may perform a multiple-tentative correction on the keyID-checked data 218C. Performing the multiple-tentative correction on the keyID-checked data 218C may result in the correction on the keyID-checked data 218C and transmission of the corresponding read data of the corrected keyID-checked data to the host system 220, or result in a failure on the correction and transmission of a failure notification to the host system 220. The detail of performing the multiple-tentative correction is illustrated with respect to FIG. 5.

FIGS. 3 and 4 are flow diagrams of example methods 300 and 400 for implementing key ID check in a compute express link (CXL) memory device, in accordance with some embodiments of the present disclosure. The methods 300 and 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the methods 300 and 400 are performed by the key ID check component 113 of FIG. 1 or FIG. 2. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

Referring to FIG. 3, at operation 310, the processing logic can receive, from a host system (e.g., host system 120 or host system 220), a write command (e.g., write command 291) comprising first data (e.g., data 218A) and a first key identifier (e.g., key ID 218B). In some implementations, the first data comprises host data and metadata of the host data. In some implementations, the first key identifier comprises a security key utilized for memory encryption using CXL-defined trusted execution environment (TEE) Security Protocol (TSP). In some implementations, the first key identifier is unique and assigned to data with a unit size.

At operation 320, the processing logic can perform a first computation on the first data (e.g., data 218A) and the first key identifier (e.g., key ID 218B) to generate second data (e.g., keyID-checked data 218C). In some implementations, the first computation comprises a Boolean logic XOR operation. In some implementations, a size of the second data equals a size of the first data.

At operation 330, the processing logic can store the second data (e.g., keyID-checked data 218C) in the memory device (e.g., memory device 130). In some implementations, the second data is stored in a segment of the memory device, wherein the segment comprises a plurality of sub-segments (e.g., block stripes, die stripes), and wherein the second data is stored across the plurality of sub-segments. At operation 340, the processing logic can store a parity value of the second data (e.g., parity data 218D of the keyID-checked data 218C) in the memory device (e.g., memory device 130). In some implementations, the processing logic can store a cyclic redundancy check (CRC) (or message authentication code (MAC)) encoding value of the first data (e.g., CRC encoding value 218E) in the memory device (e.g., memory device 130).

Referring to FIG. 4, at operation 410, the processing logic can receive, from a host system (e.g., host system 120 or host system 220), a read command (e.g., read command 293) comprising a second key identifier (e.g., key ID 218B) and an address of the second data (e.g., an address of the keyID-checked data 218C). In some implementations, the second key identifier comprises a security key utilized for memory encryption using CXL-defined trusted execution environment (TEE) Security Protocol (TSP). In some implementations, the second key identifier is unique and assigned to data with a unit size. In some implementations, the second key identifier is the same as the first key identifier.

At operation 420, the processing logic can perform a second computation on the second data (e.g., keyID-checked data 218C) and the second key identifier (e.g., key ID 218B) to generate third data (e.g., read data 218F). In some implementations, the second computation comprises a Boolean logic XOR operation.

At operation 430, the processing logic can determine whether a cyclic redundancy check (CRC) (or message authentication code (MAC)) decoding value of the third data (e.g., CRC decoding value 218G) equals a cyclic redundancy check (CRC) (or message authentication code (MAC)) encoding value of the first data (e.g., CRC decoding value 218E). At operation 440, responsive to determining that the cyclic redundancy check (CRC) (or message authentication code (MAC)) decoding value of the third data equals the cyclic redundancy check (CRC) (or message authentication code (MAC)) encoding value of the first data, the processing logic can send the third data (e.g., read data 218F) to respond to the read command (e.g., read command 293). At operation 450, responsive to determining that the cyclic redundancy check (CRC) (or message authentication code (MAC)) decoding value of the third data does not equal the cyclic redundancy check (CRC) (or message authentication code (MAC)) encoding value of the first data, the processing logic can perform a multi-tentative correction on the second data (e.g., keyID-checked data 218C). In some implementations, the multi-tentative correction on the second data is performed using the second data, the parity value of the second data, a cyclic redundancy check (CRC) (or message authentication code (MAC)) encoding value of the first data, and the second key identifier.

In some implementations, the processing logic can determine that an error exists in the second data and correct the error in the second data to generate fourth data. In some implementations, the processing logic can determine that multiple errors exist in the second data. In some implementations, the processing logic can determine that no errors exist in the second data. At operation 460, the processing logic can send the fourth data to respond to the read command (e.g., read command 293) or a notification regarding errors to respond to the read command (e.g., read command 293).

FIG. 5 illustrates an example of the multiple-tentative correction on data stored in a management unit (MU) stripe (e.g., die stripe, block stripe, etc.) in a portion of the memory device. To perform the multiple-tentative correction as described at operation 450, the processing logic can retrieve the keyID checked data 518C, where the keyID checked data 518C is stored in a MU stripe that contains ten MUs. The keyID checked data 518C may include keyID checked host data and keyID checked metadata. For example, eight MUs (e.g., i=0, 1, . . . 7) are used to store the keyID checked host data, one MU (e.g., i=8) is used to store the keyID checked metadata, and the last MU is used to store the parity data 518D. In one example, the CRC (or MAC) encoding value 518E is stored in the same MU with the keyID checked metadata.

To identify the MU where the error is located, each MU in a MU stripe is checked. Specifically, the processing logic can recover the first MU (e.g., i=0) of the keyID checked data 518C using the parity data 518D to generate recovered data of the first MU (e.g., i=0). The processing logic can use the recovered data of the first MU to replace the data of the first MU to obtain the recovered data 518N. The processing logic can convert the recovered data 518N to the read data 518F, for example, through an operation that is similar to the second computation described above, such as a Boolean logic XOR operation. The processing logic can decode the read data 518F to derive the CRC (or MAC) decoding value 518G. The processing logic can compare the CRC (or MAC) decoding value 518G with the CRC (or MAC) decoding value 518E and determine whether the CRC (or MAC) decoding value 518G equals the CRC (or MAC) decoding value 518E. Responsive to determining that the CRC (or MAC) decoding value 518G equals the CRC (or MAC) decoding value 518E, the processing logic can determine that the first MU does not contain the error. Responsive to determining that the CRC (or MAC) decoding value 518G does not equal the CRC (or MAC) decoding value 518E, the processing logic can determine that the first MU contains the error. The processing logic can repeat the process for each MU (e.g., i=0, 1, . . . 8) of the keyID checked data 518C to determine whether the MU contains the error.

Therefore, the processing logic can determine that no MU, one MU, or multiple MUs contain error(s). In the case that one MU contains the error, the processing logic can use the recovered data 518N as the corrected third data and send it to the host system 220. For example, as shown in FIG. 5, the fourth MU (e.g., i=3) is determined to contain the error, and the recovered data 518N, which includes the recovered data of the fourth MU, is used as the corrected third data and to be sent to the host system 220. In the case that no MU contains the error, the processing logic can send, to the host system 220, a notification that the key ID is incorrect. In the case that multiple MUs contain the error, the processing logic can send, to the host system 220, a notification that a correction is failed because of a great number of errors.

FIG. 6 illustrates an example of keyID-checked data. The keyID-checked data may be stored in a die stripe 600 that contains ten dies 0-9. The keyID checked data may include keyID checked host data and keyID checked metadata. The dies 0-7 are used to store the keyID checked host data, the die 8 is used to store the keyID checked metadata and the CRC (or MAC) encoding value, and the die 9 is used to store the parity data. The key ID may be 12 bits and “checked” (e.g., XORed) in the keyID checks host data with a great distribution among the eight dies 0-7. As shown in the FIG. 6, the numbers 1-12 represent the 12 bits of the key ID being checked. The distribution among all eight dies is required because if only a single die contains the KeyID bits checked with the host data, the data recovery using the parity data may result in mismatch.

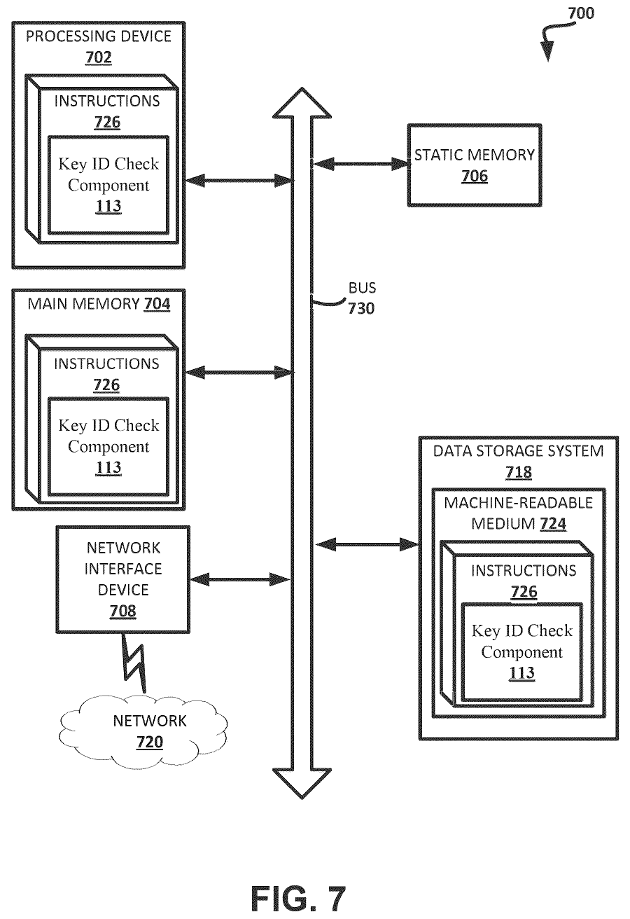

FIG. 7 illustrates an example machine of a computer system 700 within which a set of instructions, for causing the machine to perform any one or more of the methodologies discussed herein, can be executed. In some embodiments, the computer system 700 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the key ID check component 113 of FIG. 1 or the controller 215 of FIG. 2). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM) or RDRAM, etc.), a static memory 706 (e.g., flash memory, static random access memory (SRAM), etc.), and a data storage system 718, which communicate with each other via a bus 730.

Processing device 702 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 702 can also be one or more special-purpose processing devices such as an application specific integrated circuit (ASIC), a field programmable gate array (FPGA), a digital signal processor (DSP), network processor, or the like. The processing device 702 is configured to execute instructions 726 for performing the operations and steps discussed herein. The computer system 700 can further include a network interface device 708 to communicate over the network 720.

The data storage system 718 can include a machine-readable storage medium 724 (also known as a computer-readable medium) on which is stored one or more sets of instructions 726 or software embodying any one or more of the methodologies or functions described herein. The instructions 726 can also reside, completely or at least partially, within the main memory 704 and/or within the processing device 702 during execution thereof by the computer system 700, the main memory 704 and the processing device 702 also constituting machine-readable storage media. The machine-readable storage medium 724, data storage system 718, and/or main memory 704 can correspond to the memory sub-system 110 of FIG. 1.

In one embodiment, the instructions 726 include instructions to implement functionality corresponding to an APL management component (e.g., the key ID check component 113 of FIG. 1 or the controller 215 of FIG. 2). While the machine-readable storage medium 724 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device; and
a processing device, operatively coupled with the memory device, to perform operations comprising:
receiving a write command comprising first data and a first key identifier;
performing a first computation on the first data and the first key identifier to generate second data;
storing the second data in the memory device; and
storing a parity value of the second data in the memory device.

2. The system of claim 1, wherein the operations further comprise:
storing a cyclic redundancy check (CRC) or message authentication code (MAC) encoding value of the first data in the memory device.

3. The system of claim 1, wherein the operations further comprise:
receiving a read command comprising a second key identifier and an address of the second data; and
performing a second computation on the second data and the second key identifier to generate third data.

4. The system of claim 3, wherein the operations further comprise:
determining whether a cyclic redundancy check (CRC) or message authentication code (MAC) decoding value of the third data equals a cyclic redundancy check (CRC) or message authentication code (MAC) encoding value of the first data; and
responsive to determining that the cyclic redundancy check (CRC) or message authentication code (MAC) decoding value of the third data equals the cyclic redundancy check (CRC) or message authentication code (MAC) encoding value of the first data, sending the third data to respond to the read command.

5. The system of claim 3, wherein the operations further comprise:
determining whether a cyclic redundancy check (CRC) or message authentication code (MAC) decoding value of the third data equals a cyclic redundancy check (CRC) or message authentication code (MAC) encoding value of the first data; and
responsive to determining that the cyclic redundancy check (CRC) or message authentication code (MAC) decoding value of the third data does not equal the cyclic redundancy check (CRC) or message authentication code (MAC) encoding value of the first data, performing a multi-tentative correction on the second data.

6. The system of claim 5, wherein the multi-tentative correction on the second data is performed using the parity value of the second data, the cyclic redundancy check (CRC) or message authentication code (MAC) encoding value of the first data, and the second key identifier.

7. The system of claim 5, wherein performing the multi-tentative correction on the second data further comprises:
determining that an error exists in the second data;
correcting the error in the second data to generate fourth data; and
sending the fourth data to respond to the read command.

8. The system of claim 5, wherein performing the multi-tentative correction on the second data further comprises:
determining that multiple errors exist in the second data; and
sending a notification to respond to the read command.

9. The system of claim 5, wherein performing the multi-tentative correction on the second data further comprises:
determining that no error exists in the second data; and
sending a notification to respond to the read command, wherein the notification is associated with the second key identifier.

10. The system of claim 3, wherein the second computation comprises a Boolean logic XOR operation.

11. The system of claim 1, wherein the first computation comprises a Boolean logic XOR operation.

12. The system of claim 1, wherein a size of the second data equals a size of the first data.

13. The system of claim 1, wherein the first key identifier is unique and assigned to data with a unit size.

14. The system of claim 1, wherein the second data is stored in a segment of the memory device, wherein the segment comprises a plurality of sub-segments, and wherein the second data is stored across the plurality of sub-segments.

15. A method comprising:
receiving, by a processing device, a write command comprising first data and a first key identifier;
performing a first computation on the first data and the first key identifier to generate second data;
storing the second data in a memory device; and
storing a parity value of the second data in the memory device.

16. The method of claim 15, further comprising:
storing a cyclic redundancy check (CRC) or message authentication code (MAC) encoding value of the first data in the memory device;
receiving a read command comprising a second key identifier and an address of the second data;
performing a second computation on the second data and the second key identifier to generate third data;
determining whether a cyclic redundancy check (CRC) or message authentication code (MAC) decoding value of the third data equals a cyclic redundancy check (CRC) or message authentication code (MAC) encoding value of the first data; and
responsive to determining that the cyclic redundancy check (CRC) or message authentication code (MAC) decoding value of the third data equals the cyclic redundancy check (CRC) or message authentication code (MAC) encoding value of the first data, sending the third data to respond to the read command.

17. The method of claim 16, further comprising:
responsive to determining that the cyclic redundancy check (CRC) or message authentication code (MAC) decoding value of the third data does not equal the cyclic redundancy check (CRC) or message authentication code (MAC) encoding value of the first data, performing a multi-tentative correction on the second data.

18. A non-transitory computer-readable storage medium comprising instructions that, when executed by a processing device, cause the processing device to perform operations comprising:
receiving, by a processing device, a write command comprising first data and a first key identifier;
performing a first computation on the first data and the first key identifier to generate second data;
storing the second data in a memory device; and
storing a parity value of the second data in the memory device.

19. The non-transitory computer-readable storage medium of claim 18, the operations further comprise:
storing a cyclic redundancy check (CRC) or message authentication code (MAC) encoding value of the first data in the memory device;
receiving a read command comprising a second key identifier and an address of the second data;
performing a second computation on the second data and the second key identifier to generate third data;
determining whether a cyclic redundancy check (CRC) or message authentication code (MAC) decoding value of the third data equals a cyclic redundancy check (CRC) or message authentication code (MAC) encoding value of the first data; and
responsive to determining that the cyclic redundancy check (CRC) or message authentication code (MAC) decoding value of the third data equals the cyclic redundancy check (CRC) or message authentication code (MAC) encoding value of the first data, sending the third data to respond to the read command.

20. The non-transitory computer-readable storage medium of claim 19, the operations further comprise:
responsive to determining that the cyclic redundancy check (CRC) or message authentication code (MAC) decoding value of the third data does not equal the cyclic redundancy check (CRC) or message authentication code (MAC) encoding value of the first data, performing a multi-tentative correction on the second data.
